(19) United States
(12) Patent Application Publication
(10) Pub. No.: US 2026/0101277 A1
(43) Pub. Date: Apr. 9, 2026

(54) GEOLOCATION BASED SERVER SELECTION FOR DEVICES IN A NETWORK

(71) Applicant: T-Mobile USA, Inc., Bellevue, WA (US)

(72) Inventors: Maulik Gajjar, Tempe, AZ (US); Bhagwan Singh Khanka, Las Vegas, NV (US)

(21) Appl. No.: 18/908,612

(22) Filed: Oct. 7, 2024

(51) Int. Cl. H04W 48/18; H04W 24/02

(52) U.S. Cl. CPC H04W 48/18; H04W 24/02

(57) ABSTRACT

A computer system obtains, from a terminal device, network data related to communication between the terminal device and a network. The network data describes multiple network servers in the network that are configured to serve the terminal device. The system identifies a first network server of the multiple network servers that is serving the terminal device. The system can select a network server, which can be the first network server or a different network server, depending on the proximity of the server to the terminal device, the server beamwidth to the terminal device, and/or the server azimuth to the terminal device.

### BACKGROUND

Network testing refers to the process of connecting to and collecting information from a cellular network at different geographical locations. The information collected describes the interactions between the cellular network and mobile devices, and can be used for network reconfiguration and management. However, conventional network testing methods (e.g., using drive testing) can be time- and resource-intensive. The time taken to perform drive testing can especially be prohibitive for large geographical areas or when the routes to be driven across a geographical area are complex.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example environment for selecting a server for devices in a network.

FIG. 4 is a flowchart that illustrates an example process for selecting a server for devices in a network.

FIG. 5 is a high-level block diagram illustrating an example AI system.

FIG. 6 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Wireless service providers collect information and measurements that describe interactions between a mobile radio network (e.g., a cellular network) and mobile devices across a geographical area to determine how users experience the network across the geographical area. The information and measurements enable the wireless providers to improve coverage and service by network enhancements. However, conventional methods for collecting network measurements (e.g., using drive testing) can be time- and resource-intensive. For example, the time taken to perform drive testing can be prohibitive for large geographical areas or when the routes to be driven across a geographical area are complex. Conventional methods for network testing can also be fuel-inefficient and can lead to excessive greenhouse gas emissions by the vehicles used to perform drive testing. There is thus a need for improved methods for collecting network performance data that are more efficient, cost-effective, and environmentally friendly.

This document discloses methods, apparatuses, and systems that provide geolocation-based server selection for devices in a network. The disclosed systems can obtain network data from a user equipment (e.g., a wireless device, a terminal device, a mobile device) that describes the terminal device’s network communication. Using the network data, the disclosed systems can identify network servers that are closer to the terminal device than other network servers and determine whether the beamwidth and the azimuth of a network server cover the terminal device. The disclosed methods can be used to select network servers that are more suitable for the terminal device to connect to for reduced latency and/or greater bandwidth.

In some implementations, the disclosed systems dynamically obtain real-time network data from terminal devices without requiring drive testing. By evaluating network parameters such as server proximity, beamwidth, and/or azimuth, the systems can identify and select a suitable server to serve the terminal device. In addition, the systems enable continuous and/or near real-time adjustments of the network parameters, leading to a more adaptive network infrastructure. Further, user experience is improved when terminal devices are connected to a suitable server due to the reduced latency and improved overall connectivity. For example, when a terminal device is identified as an overshooter, a handover process can be initiated to switch the terminal device's connection to a more suitable server. An overshooter refers to terminal devices that connect to a distant server despite being closer to another, more suitable server. Overshooters can lead to network inefficiencies, increased latency, and degraded performance because the connection to a distant server may not be as strong or reliable as a connection to a closer server. Using real-time adjustments, the occurrence of overshooters is reduced, and network performance is improved.

Further, the methods disclosed herein can cause a reduction in greenhouse gas emissions compared to traditional methods for testing telecommunication networks. Every year, approximately 40 billion tons of CO² are emitted around the world. Power consumption by digital technologies including telecommunications networks account for approximately 4% of this figure. Further, conventional methods for network performance evaluation that rely on the use of gas-powered vehicles can exacerbate the causes of climate change. The implementations for geolocation-based server selection disclosed herein can mitigate climate change by reducing and/or preventing additional greenhouse gas emissions into the atmosphere. For example, by reducing the need for drive testing, the disclosed systems reduce fuel consumption and the associated emissions from vehicles used in drive testing. Additionally, the near real-time adjustments to the network reduce the overall energy consumption of the network by lowering unnecessary power usage, further contributing to lower carbon emissions. Therefore, the disclosed implementations for selecting network servers using the network data of the terminal device mitigate climate change and the effects of climate change by preventing additional greenhouse gas emissions and reducing unnecessary electrical power usage in comparison to conventional network technologies.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

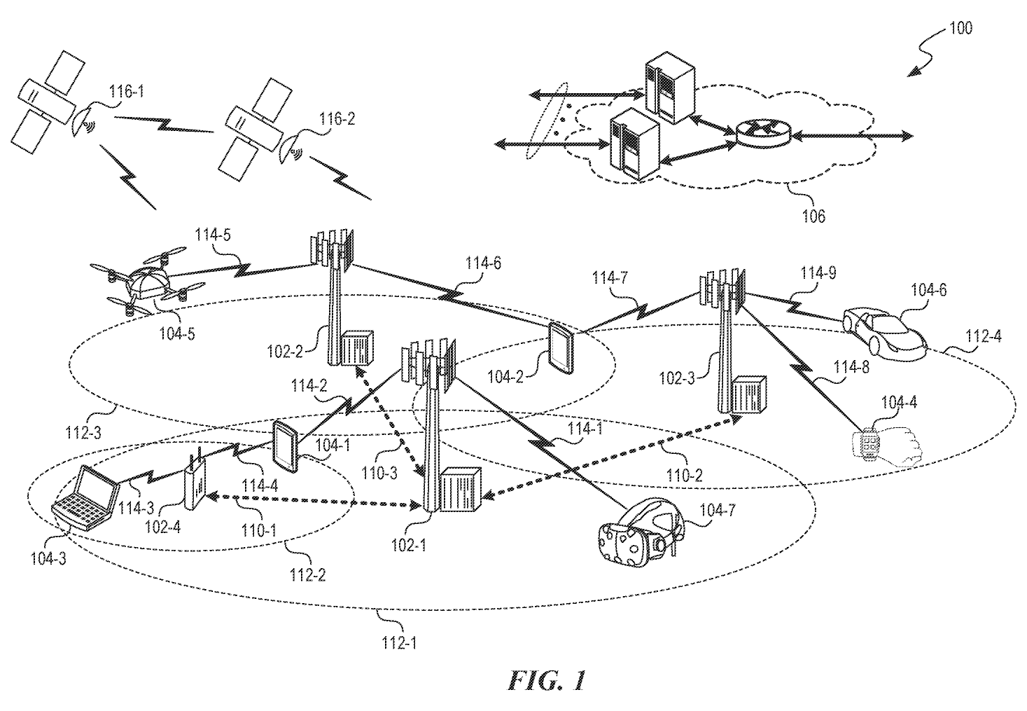

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 402.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces for LTE) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., Xn interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

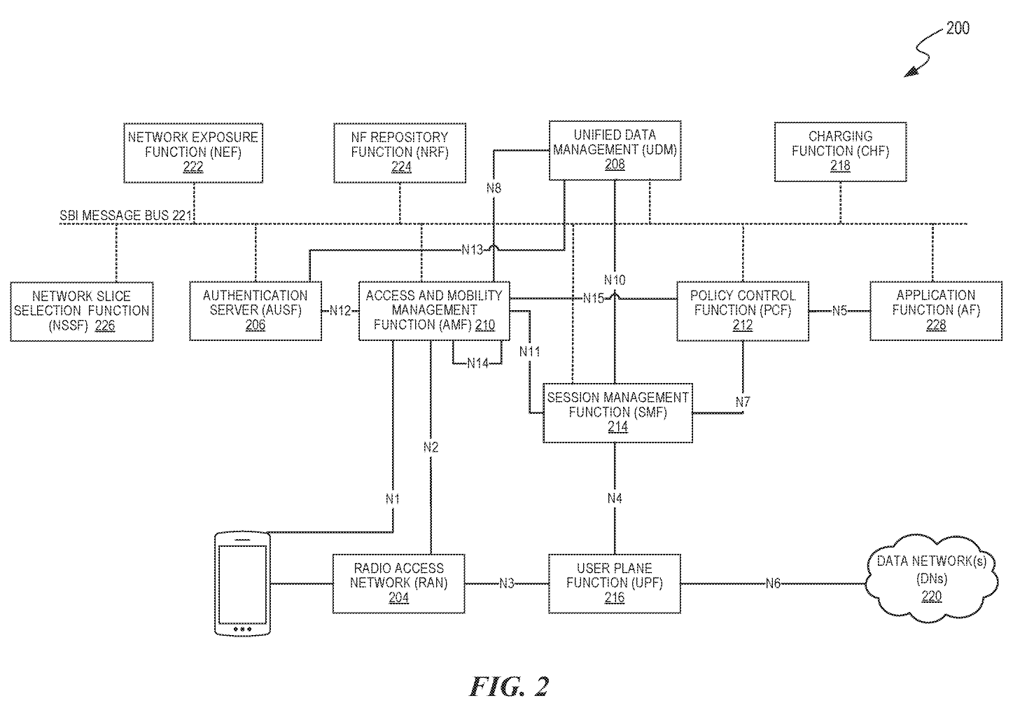

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Geolocation-Based Server Selection

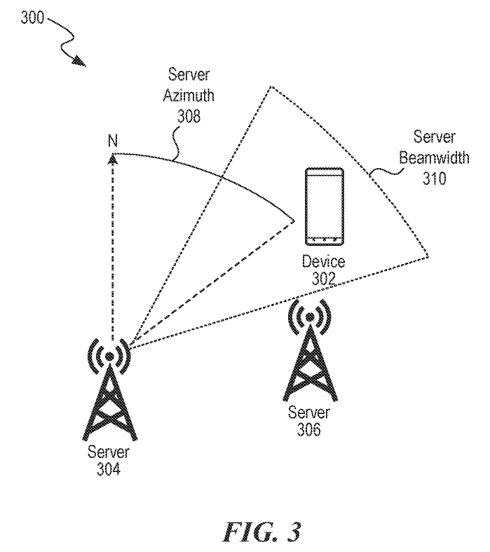

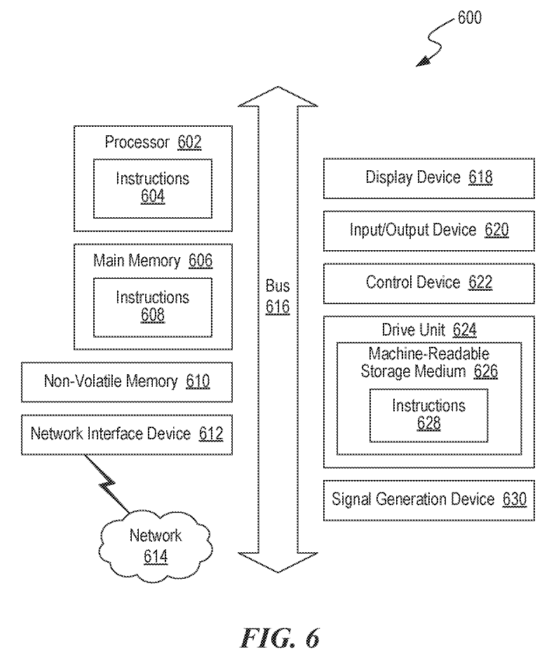

FIG. 3 is a block diagram that illustrates an example environment 300 for selecting a server for terminal devices in a network. The environment 300 represents a geographical area serviced by the network. The environment 300 includes a terminal device 302 and servers 304, 306 of the network. The network is the same as or similar to network 100, illustrated and described in more detail with reference to FIG. 1. Terminal device 302 and servers 304, 306 can be implemented using components of the example computer system 600 illustrated and described in more detail with reference to FIG. 6. Implementations of example environment 300 can include different and/or additional components or can be connected in different ways.

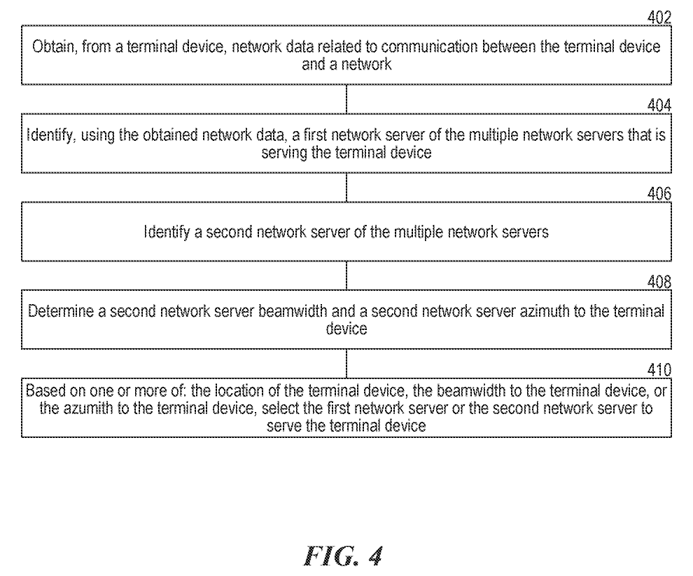

The terminal device 302 can be any user equipment such as a smartphone, tablet, or laptop. In some implementations, the terminal device 302 is the same as or similar to the wireless devices 104-1 through 104-7, illustrated and described in more detail with reference to FIG. 1. The terminal device 302 communicates with the network and can provide network data related to its communication. The network data can include, for example, information about the signal strength, the terminal device's location, movement patterns, data usage, battery status, processing capabilities, application usage, and other parameters used to identify a suitable server to serve the terminal device 302. For example, a suitable server can provide greater bandwidth or less latency of communication to the terminal device 302 than the server presently connected to the terminal device 302 is providing. Further examples of the network data collected and the methods of obtaining the network data are discussed in further detail with reference to FIG. 4.

The servers 304, 306 can be network nodes that are available to provide connectivity and services to the terminal device 302. For example, in FIG. 3, server 304 is currently serving the terminal device, while server 306 is not serving the terminal device 302. An available server (e.g., server 306) not currently serving the terminal device 302 can be identified to determine whether to switch the terminal device 302 from server 304 to the identified server 306. Methods of determining conditions/triggers under which to switch the current server to the identified server are discussed in further detail with reference to FIG. 4.

The server azimuth 308 with respect to the terminal device 302 can be defined as an angular distance viewed from server 304 between a point on the horizon to a location where a vertical circle passing through the terminal device 302 intersects the horizon. For example, the server azimuth 308 can be used to determine a direction of the terminal device 302 from server 304. The server azimuth 308 can be used to identify the location of the terminal device 302 relative to server 304. In some embodiments, the server azimuth 308 is used in conjunction with other metrics, such as the server beamwidth 310, a distance from the server 304 to the terminal device 302, and/or an elevation of the server 304 with respect to the terminal device, to determine the server’s coverage area. For example, in FIG. 3, the azimuth 308 is a measure of the angular distance between a north-facing reference direction and server 304, expressed in degrees.

The server beamwidth 310 with respect to the terminal device 302 can be defined as an angular width of the server’s antenna radiation pattern. The server beamwidth 310 can be determined by the diameter of a beam emitted by the server 304 along a line perpendicular to the beam axis and intersecting the beam axis. For example, the beamwidth 310 can be used to determine the spread of the wireless signals in the horizontal plane that, in FIG. 3, cover the terminal device 302. A wider beamwidth can cover more area but may result in weaker signal strength, while a narrower beamwidth provides a stronger signal but covers less area. For example, the server beamwidth 310 is a measure of the width of the signal beam of server 304, expressed in degrees.

In some implementations, a distance of a server to the terminal device 302 and/or an elevation (the vertical angle between the server and the terminal device) is used to select a suitable server. For example, the distance between the server 304 and the terminal device 302 can be used to identify the range of the server’s coverage and determine how far the wireless signals emitted by the server 304 can travel while maintaining a reliable connection. The azimuth and beamwidth together can be used to determine the horizontal sector of wireless coverage, while the distance can define the radial extent of the coverage area within that sector. The elevation can be used to identify the vertical coverage of the coverage area (e.g., the elevation can cause differing coverage quality in environments with varying terrain or multi-story buildings).

An available server (e.g., server 306) that is not currently serving the terminal device 302 can be closer in proximity to the terminal device 302, while a server (e.g., server 304) that is presently connected to the terminal device 302 is further away. For example, if the azimuth and the beamwidth of the server 306 covers the terminal device 302, the terminal device 302 can be switched from server 304 to the closer server (server 306). Methods of selecting a more suitable server based on the beamwidth and azimuth of the server to the terminal device, the distance between the server and the terminal device 302, and/or elevation are discussed in further detail with reference to FIG. 4. Dynamically switching servers based on geo-location can improve network performance. For example, the disclosed systems can improve network performance as measured by latency, jitter, packet loss, throughput, network speed, bandwidth, network availability, packet duplication, packet reordering, user quality of experience, VoIP quality, network congestion, round-trip time (RTT), network utilization, error rate, and/or transfer control protocol (TCP) retransmission rate.

FIG. 4 is a flowchart that illustrates an example process 400 for selecting a server for devices in a network. In some implementations, the process 400 is performed by a system including components of the example computer system 600 illustrated and described in more detail with reference to FIG. 6. The system can be implemented on a terminal device, a server, or on a telecommunications network core. Likewise, implementations can include different and/or additional operations or can perform the operations in different orders.

In act 402, the system obtains, from a terminal device (e.g., terminal device 302 in FIG. 3), network data related to communication between the terminal device and a network. The network data can describe multiple network servers in the network that are configured to serve the terminal device. The network data can include various parameters such as signal strength, signal-to-noise ratio (SNR), bit error rate (BER), device location (using GPS or triangulation methods), movement patterns, data usage, battery status, processing capabilities, and/or application usage. The terminal device can continuously monitor and collect the network metrics of the network data using built-in sensors and communication modules.

In act 404, the system identifies, using the obtained network data, a first network server (e.g., server 304 in FIG. 3) of the multiple network servers serving the terminal device. For example, the system can parse the network data received from the terminal device, which can include identifiers such as a server's IP address, MAC address, or unique server ID. The system can cross-reference the obtained information with a database of network servers to pinpoint the specific server currently handling the terminal device's communication (e.g., by querying the database using SQL or NoSQL queries to match the server identifiers).

In some implementations, the system can use network topology maps and routing tables to verify the server's location and status. Network topology maps can provide a visual representation of the network's structure, showing how different network nodes, such as servers, routers, and/or switches, are interconnected and can define the relative positions of the servers and the paths data takes through the network. Routing tables, on the other hand, can include information about the routes data packets are expected to take to reach their destinations. Each entry in a routing table can include a destination IP address, a subnet mask, the next hop address, and/or metrics such as hop count or link cost. By using information from network topology maps and/or routing tables, the system can verify the server's location and status. For example, if the network data indicates that a particular server is serving the terminal device, the system can cross-check the information against the topology map to confirm the server's physical location and/or use routing tables to ensure that the data paths align with the expected routes, verifying that the server is active and correctly positioned within the network.

In act 406, the system identifies a second network server (e.g., server 306 in FIG. 3) of the multiple network servers. Criteria to select the second server can be pre-defined (e.g., the closest server) or can be defined dynamically based on near real-time network conditions and performance metrics. For example, the system can use the data to scan the network for other available servers that can potentially serve the terminal device by querying a centralized server registry or database including information about multiple network servers, including their current load, capacity, and geographical location. The system can filter and rank these servers based on criteria such as proximity to the terminal device, current load, and/or historical performance metrics using methods discussed with reference to act 410.

In act 408, the system determines a second network server beamwidth to the terminal device and a second network server azimuth with respect to the terminal device. The second network server beamwidth can be determined by a diameter of a beam from the second network server along a line that is perpendicular to a beam axis and intersects the beam axis. For example, the system can use the server's antenna specifications and the distance to the terminal device to measure the second network server beamwidth. The second network server azimuth can represent a direction of the terminal device from the second network server. The second network server azimuth can be determined, at the second network server, by an angular distance from a point on a horizon to a location at which a vertical circle passing through the terminal device intersects the horizon. For example, the system can use the server's geographical coordinates and the terminal device's coordinates to compute the azimuth angle. In some implementations, the system can determine the distance and/or elevation of the server relative to the terminal device.

In act 410, the system selects the first network server or the second network server to serve the terminal device based on the location of the terminal device, the beamwidth to the terminal device, and/or the azimuth to the terminal device. The selection can be rule-based, where predefined criteria such as minimum signal strength thresholds, maximum allowable latency, and/or server load limits are used to make the selection.

In some implementations, the closest server not currently serving the terminal device is selected to serve the terminal device (e.g., in the scenario where the terminal device moves geographical locations). The system can determine the geographical coordinates of the terminal device and determine the distances to available servers. The system can identify the server that is geographically closest to the terminal device. The system can verify that the closest server meets other predefined criteria, such as having sufficient capacity and/or acceptable signal strength (e.g., signal strength and capacity above a predefined threshold). If the closest server satisfies the conditions, the system can switch the terminal device's connection to the closest server.

In some examples, the second network server is geographically (e.g., located) closer than the first network server to the terminal device. The system can determine a second network server beamwidth and a second network server azimuth to the terminal device, and determine that the second network server beamwidth and the second network server azimuth cover the terminal device. In response to determining that the second network server beamwidth and the second network server azimuth cover the terminal device, the system can select the second network server to serve the terminal device. In some implementations, the system can determine that the second network server beamwidth and the second network server azimuth fail to cover the terminal device. Responsive to determining that the second network server beamwidth and the second network server azimuth fail to cover the terminal device, the system can cause the first network server to continue serving the terminal device.

In some implementations, the system determines that the location of the terminal device has changed. The system can identify the closest network server of the multiple network servers to the terminal device. For example, the system can identify a third network server of the multiple network servers that is geographically closer than the second network server to the terminal device. In response to determining that a third network server beamwidth and a third network server azimuth to the terminal device cover the terminal device, the system can select the third network server to serve the terminal device. The system can determine a respective distance (e.g., using GPS data) between the terminal device and each network server of the multiple network servers, wherein the second network server is identified based on the determined respective distance. The system can, based on the comparison, select a second network server from the one or more other network servers, where a second network server beamwidth and a second network server azimuth cover the terminal device.

The system can compare the first network server with one or more other network servers of the multiple network servers based on the beamwidth of each of the one or more other network servers and an azimuth of each of the one or more other network servers. In some implementations, when a significant drop in signal quality (e.g., measured using SNR, RSSI, BER) is detected, the system can dynamically evaluate the beamwidth and azimuth of the first network server and compare them with those of other available network servers. The dynamic assessment allows the system to switch the terminal device to a server that can provide better signal quality, thereby improving the user experience. The system can, in some implementations, dynamically determine the selection based on the current load and traffic conditions of the network servers. For instance, if the first network server is experiencing high traffic and nearing its capacity, the system can evaluate the beamwidth and azimuth of other network servers to find a suitable alternative. By comparing these parameters, the system can dynamically select a less congested server that still provides adequate coverage, ensuring efficient load balancing and consistent network performance.

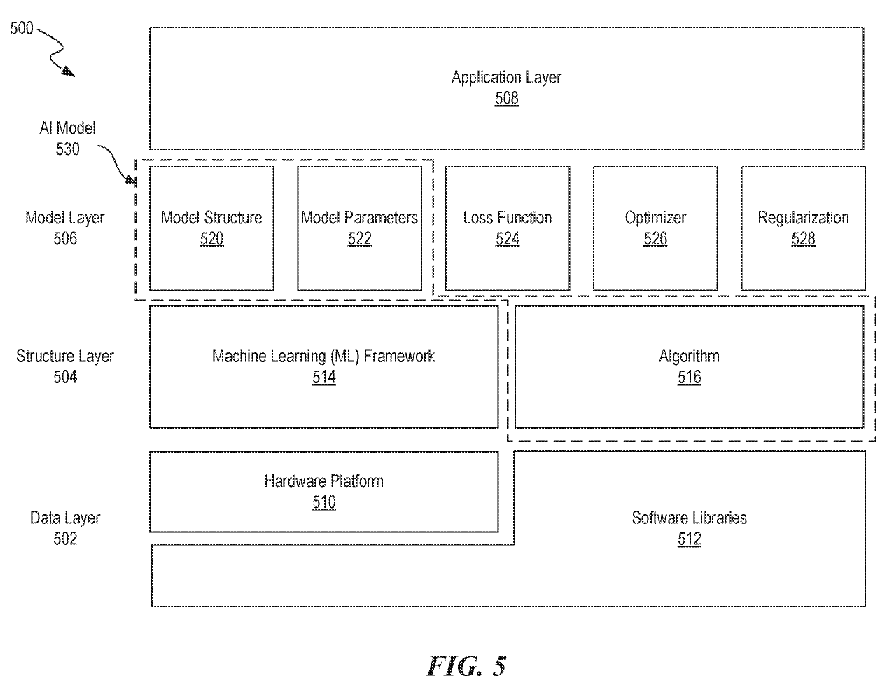

In some implementations, the system can apply one or more machine learning models to select a server for a terminal device. For example, the machine learning model(s) can be used to select a network server for the terminal device based on various input features such as signal strength, beamwidth, azimuth, server load, and/or user location. The machine learning model(s) can be trained on historical data where the expected server selections are known. Once trained, the model can dynamically evaluate the current conditions and make real-time decisions on which server to select. In some implementations, models such as deep learning models can be used to capture patterns and relationships in the network data. For example, the models can be used to classify the selected server based on input features. The models can be trained on historical data to learn the decision boundaries that separate different server selections. Examples of models used are discussed with reference to FIG. 5.

The system can, in some implementations, generate one or more actions that disconnect the first network server from the terminal device, and/or connect the second network server to the terminal device. For example, when the system determines that the terminal device should switch from the first network server to the second network server, the system can initiate a series of actions to disconnect the terminal device from the first network server. The system can send a session termination request to the first network server, release the resources allocated to the terminal device, synchronize the state information of the terminal device with the second network server, and/or notify the terminal device of the disconnection. Once the terminal device is disconnected from the first network server, the system can initiate a series of actions to establish a connection with the second network server by sending a connection request to the second network server, allocating the necessary resources for the terminal device, performing authentication and authorization checks, restoring the state information of the terminal device, and/or notifying the terminal device of the connection to the second network server.

### AI SYSTEM

FIG. 5 is a block diagram illustrating an example artificial intelligence (AI) system 500. The AI system 500 is implemented using components of the example computer system 600 illustrated and described in more detail with reference to FIG. 6. For example, the AI system 500 can be implemented using the processor 602 and instructions 608 programmed in the memory 606 illustrated and described in more detail with reference to FIG. 6. Likewise, implementations of the AI system 500 can include different and/or additional components or be connected in different ways.

As shown, the AI system 500 can include a set of layers, which conceptually organize elements within an example network topology for the AI system’s architecture to implement a particular AI model 530. Generally, an AI model 530 is a computer-executable program implemented by the AI system 500 that analyzes data (e.g., signal strength, signal-to-noise ratio (SNR), bit error rate (BER), device location (using GPS or triangulation methods), movement patterns, data usage, battery status, processing capabilities, and/or application usage) to make predictions (e.g., the closest server, the suitable server). Information can pass through each layer of the AI system 500 to generate outputs for the AI model 530. The layers can include a data layer 502, a structure layer 504, a model layer 506, and an application layer 508. The algorithm 516 of the structure layer 504 and the model structure 520 and model parameters 522 of the model layer 506 together form the example AI model 530. The optimizer 526, loss function engine 524, and regularization engine 528 work to refine and optimize the AI model 530, and the data layer 502 provides resources and support for application of the AI model 530 by the application layer 508.

The data layer 502 acts as the foundation of the AI system 500 by preparing data for the AI model 530. As shown, the data layer 502 can include two sub-layers: a hardware platform 510 and one or more software libraries 512. The hardware platform 510 can be designed to perform operations for the AI model 530 and include computing resources for storage, memory, logic, and networking, such as the resources described in relation to FIG. 6. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 510 can include Infrastructure as a Service (IaaS) resources, which are computing resources, (e.g., servers, memory, etc.) offered by a cloud services provider. The hardware platform 510 can also include computer memory for storing data about the AI model 530, application of the AI model 530, and training data for the AI model 530. The computer memory can be a form of random-access memory (RAM), such as dynamic RAM, static RAM, and non-volatile RAM.

The software libraries 512 can be thought of as suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource’s instruction set architecture, allowing them to run quickly with a small memory footprint. Examples of software libraries 512 that can be included in the AI system 500 include Intel Math Kernel Library, Nvidia cuDNN, Eigen, and Open BLAS.

The structure layer 504 can include a machine learning (ML) framework 514 and an algorithm 516. The ML framework 514 can be thought of as an interface, library, or tool that allows users to build and deploy the AI model 530. The ML framework 514 can include an open-source library, an application programming interface (API), a gradient-boosting library, an ensemble method, and/or a deep learning toolkit that work with the layers of the AI system facilitate development of the AI model 530. For example, the ML framework 514 can distribute processes for application or training of the AI model 530 across multiple resources in the hardware platform 510. The ML framework 514 can also include a set of pre-built components that have the functionality to implement and train the AI model 530 and allow users to use pre-built functions and classes to construct and train the AI model 530. Thus, the ML framework 514 can be used to facilitate data engineering, development, hyperparameter tuning, testing, and training for the AI model 530.

Examples of ML frameworks 514 or libraries that can be used in the AI system 500 include TENSORFLOW, PYTORCH, SCIKIT-LEARN, KERAS, AND CAFFFE. Random Forest is a machine learning algorithm that can be used within the ML frameworks 514. LightGBM is a gradient boosting framework/algorithm (an ML technique) that can be used. Other techniques/algorithms that can be used are XGBoost, CatBoost, etc. AMAZON WEB SERVICES is a cloud service provider that offers various machine learning services and tools (e.g., SAGE MAKER) that can be used for platform building, training, and deploying ML models.

In some implementations, the ML framework 514 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 500. For example, the ML framework 514 can use a cascade of multiple layers of nonlinear processing units for implicit feature extraction and transformation. Each successive layer uses the output from the previous layer as input. The AI model 530 can thus learn in supervised (e.g., classification) and/or unsupervised (e.g., pattern analysis) modes. The AI model 530 can learn multiple levels of representations that correspond to different levels of abstraction, wherein the different levels form a hierarchy of concepts. In this manner, AI model 530 can be configured to differentiate features of interest from background features.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model 530 through being trained while running computing resources of the hardware platform 510. The training allows the algorithm 516 to make predictions or decisions without being explicitly programmed to do so. Once trained, the algorithm 516 can run at the computing resources as part of the AI model 530 to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data can be labeled by an external user or operator. The user can label the training data based on one or more classes and trains the AI model 530 by inputting the training data to the algorithm 516. The algorithm determines how to label the new data based on the labeled training data. The user can facilitate collection, labeling, and/or input via the ML framework 514. In some instances, the user can convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data relate to the categories. Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Another way unsupervised learning is used to train the algorithm 516 to find an underlying structure of a set of data is to group the data according to similarities and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that can be used by the algorithm 516 include factor analysis, item response theory, latent profile analysis, and latent class analysis.

In some implementations, the AI system 500 trains the algorithm 516 of AI model 530, based on the training data, to correlate the feature vector to expected outputs in the training data. As part of the training of the AI model 530, the AI system 500 forms a training set of features and training labels by identifying a positive training set of features that have been determined to have a desired property in question, and, in some implementations, forms a negative training set of features that lack the property in question. The AI system 500 applies ML framework 514 to train the AI model 530, that when applied to the feature vector, outputs indications of whether the feature vector has an associated desired property or properties, such as a probability that the feature vector has a particular Boolean property, or an estimated value of a scalar property. The AI system 500 can further apply dimensionality reduction (e.g., via linear discriminant analysis (LDA), PCA, or the like) to reduce the amount of data in the feature vector to a smaller, more representative set of data.

The model layer 506 implements the AI model 530 using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model 530 of the AI system 500. The model structure 520 defines the complexity of the pattern/relationship that the AI model 530 expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node’s activation function defines how to node converts data received to data output. The structure layers can include an input layer of nodes that receive input data, an output layer of nodes that produce output data. The model structure 520 can include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For example, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model’s 530 performance during training. For example, the loss function engine 524 can measure the difference between a predicted output of the AI model 530 and the actual output of the AI model 530 and is used to guide optimization of the AI model 530 during training to minimize the loss function. The loss function can be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model 530. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used can be determined based on the type of model structure 520 and the size of data and the computing resources available in the data layer 502.

The regularization engine 528 executes regularization operations. Regularization is a technique that prevents over- and under-fitting of the AI model 530. Overfitting occurs when the algorithm 516 is overly complex and too adapted to the training data, which can result in poor performance of the AI model 530. Underfitting occurs when the algorithm 516 is unable to recognize even basic patterns from the training data such that it cannot perform well on training data or on validation data. The regularization engine 528 can apply one or more regularization techniques to fit the algorithm 516 to the training data properly, which helps constraint the resulting AI model 530 and improves its ability for generalized application. Examples of regularization techniques include lasso (L1) regularization, ridge (L2) regularization, and elastic (L1 and L2 regularization).

In some implementations, the AI system 500 can include a feature extraction module implemented using components of the example computer system 600 illustrated and described in more detail with reference to FIG. 6. In some implementations, the feature extraction module extracts a feature vector from input data. The feature vector includes n features (e.g., feature a, feature b, . . ., feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 530 by using the reduced representation. In some example implementations, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in the specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite the change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having acts, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We Claim:

1. A system comprising:
at least one hardware processor; and
at least one non-transitory memory storing instructions, which, when executed by the at least one hardware processor, cause the system to:
obtain, from a terminal device, network data related to communication between the terminal device and a network,
wherein the network data describes multiple network servers in the network that are configured to serve the terminal device;
identify, using the obtained network data, a first network server of the multiple network servers that is serving the terminal device;
identify a second network server of the multiple network servers that is geographically closer than the first network server to the terminal device;
determine a second network server beamwidth and a second network server azimuth to the terminal device;
determine that the second network server beamwidth and the second network server azimuth cover the terminal device; and
responsive to determining that the second network server beamwidth and the second network server azimuth cover the terminal device, select the second network server to serve the terminal device.

2. The system of claim 1, wherein the system is further caused to:
determine that a location of the terminal device has changed;
identify a third network server of the multiple network servers that is geographically closer than the second network server to the terminal device; and
responsive to determining that a third network server beamwidth and a third network server azimuth to the terminal device cover the terminal device,
select the third network server to serve the terminal device.

3. The system of claim 1, wherein the system is further caused to:
generate one or more actions configured to:
disconnect the first network server from the terminal device; and
connect the second network server to the terminal device.

4. The system of claim 1,
wherein the second network server azimuth represents a direction of the terminal device from the second network server, and
wherein the second network server azimuth is determined, at the second network server, by an angular distance from a point on a horizon to a location at which a vertical circle passing through the terminal device intersects the horizon.

5. The system of claim 1, wherein the second network server beamwidth is determined by a diameter of a beam from the second network server along a line that is perpendicular to a beam axis and intersects the beam axis.

6. The system of claim 1, wherein the system is further caused to:
determine that a location of the terminal device has changed;
determine that the first network server of the multiple network servers is geographically closer than the second network server to the terminal device; and
responsive to determining that a first network server beamwidth and a first network server to the terminal device cover the terminal device, select the first network server to serve the terminal device.

7. The system of claim 1, wherein the system is caused to:
determine a respective distance between the terminal device and each network server of the multiple network servers, wherein the second network server is identified based on the determined respective distance.

8. A non-transitory, computer-readable storage medium comprising instructions recorded thereon, wherein the instructions when executed by at least one data processor of a computer system, cause the computer system to:
obtain, from a terminal device, network data related to communication between the terminal device and a network,
wherein the network data describes multiple network servers in the network that are configured to serve the terminal device;
identify, using the obtained network data, a first network server of the multiple network servers that is serving the terminal device;
identify a second network server of the multiple network servers that is geographically closer than the first network server to the terminal device;
determine a second network server beamwidth and a second network server azimuth to the terminal device;
determine that the second network server beamwidth and the second network server azimuth fail to cover the terminal device; and
responsive to determining that the second network server beamwidth and the second network server azimuth fail to cover the terminal device,
cause the first network server to continue serving the terminal device.

9. The non-transitory, computer-readable storage medium of claim 8, wherein the instructions cause the system to:
identify a third network server of the multiple network servers that is geographically closer than the first network server to the terminal device; and
responsive to determining that a third network server beamwidth a third network server azimuth to the terminal device cover the terminal device, select the third network server to serve the terminal device.

10. The non-transitory, computer-readable storage medium of claim 8, wherein the instructions cause the system to:
determine that a location of the terminal device has changed; and
identify a closest network server of the multiple network servers to the terminal device.

11. The non-transitory, computer-readable storage medium of claim 8, wherein the instructions cause the system to:
reduce greenhouse gas emissions by avoiding operation of physical drive test vehicles to obtain the network data related to communication between the terminal device and a network.

12. The non-transitory, computer-readable storage medium of claim 8, wherein the instructions cause the system to:
generate one or more actions configured to:
disconnect the first network server from the terminal device; and
connect the second network server to the terminal device.

13. The non-transitory, computer-readable storage medium of claim 8, wherein the second network server azimuth represents a direction of the terminal device from the second network server, and
wherein the second network server azimuth is determined, at the second network server, by an angular distance from a point on a horizon to a location at which a vertical circle passing through the terminal device intersects the horizon.

14. The non-transitory, computer-readable storage medium of claim 8, wherein the second network server beamwidth is determined by a diameter of a beam from the second network server along a line that is perpendicular to a beam axis and intersects the beam axis.

15. A method comprising:
obtaining, from a terminal device, network data related to communication between the terminal device and a network,
wherein the network data identifies multiple network servers in the network that are configured to serve the terminal device;
identifying, using the obtained network data, a first network server of the multiple network servers that is serving the terminal device;
comparing the first network server with one or more other network servers of the multiple network servers based on a beamwidth of each of the one or more other network servers and an azimuth of the each of the one or more other network servers; and
based on the comparison, selecting a second network server from the one or more other network servers,
wherein a second network server beamwidth and a second network server azimuth cover the terminal device.

16. The method of claim 15, comprising:
determining that a location of the terminal device has changed;
identifying a third network server of the multiple network servers that is geographically closer than the second network server to the terminal device; and
responsive to determining that a third network server beamwidth and a third network server azimuth to the terminal device cover the terminal device, selecting the third network server to serve the terminal device.

17. The method of claim 15, comprising:
generating one or more actions configured to:
disconnect the first network server from the terminal device; and
connect the second network server to the terminal device.

18. The method of claim 15,
wherein the second network server azimuth represents a direction of the terminal device from the second network server, and
wherein the second network server azimuth is determined, at the second network server, by an angular distance from a point on a horizon to a location at which a vertical circle passing through the terminal device intersects the horizon.

19. The method of claim 15, wherein the second network server beamwidth is determined by a diameter of a beam from the second network server along a line that is perpendicular to a beam axis and intersects the beam axis.

20. The method of claim 15, comprising:
determining a respective distance between the terminal device and each network server of the multiple network servers, wherein the second network server is identified based on the determined respective distance.
